(19) United States
(12) Patent Application Publication
(10) Pub. No.: US 2008/0278838 A1
(43) Pub. Date: Nov. 13, 2008

(54) Thermal asperity detector and methods for use therewith

(75) Inventor: Michael Le, Laguna Niguel, CA (US)

Correspondence Address: GARLICK HARRISON & MARKISON, P.O. BOX 160727, AUSTIN, TX, 78716-0727, US

(73) Assignee: Broadcom Corporation, Irvine, CA (US)

(21) Appl. No.: 11/801,527

(22) Filed: May 10, 2007

(51) Int. Cl. G11B 5/09

(52) U.S. Cl. 360/46

(57) ABSTRACT

A thermal asperity detector for use in a hard disk drive includes a magnitude detector that produces a magnitude signal from a read head signal. A filter module filters the magnitude signal to produce a amplitude signal. A comparator compares the amplitude signal to an amplitude thermal asperity threshold and that generates thermal asperity data when the amplitude signal compares favorably to the thermal asperity threshold.

### CROSS REFERENCE TO RELATED PATENTS

Not applicable

### BACKGROUND OF THE INVENTION

1. Technical Field of the Invention

The present invention relates to disk drives and read head processing to detect thermal asperities.

2. Description of Related Art

As is known, many varieties of disk drives, such as magnetic disk drives are used to provide data storage for a host device, either directly, or through a network such as a storage area network (SAN) or network attached storage (NAS). Typical host devices include stand alone computer systems such as a desktop or laptop computer, enterprise storage devices such as servers, storage arrays such as a redundant array of independent disks (RAID) arrays, storage routers, storage switches and storage directors, and other consumer devices such as video game systems and digital video recorders. These devices provide high storage capacity in a cost effective manner.

As a magnetic hard drive is manufactured it is formatted at the factory. The formatting process typically includes at least one stage where data is read to the drive in a physical mode corresponding to the physical parameters of the drive. For example, a disk drive with 1024 cylinders, 256 heads and 63 sectors per track has (1024)×(256)×(63)=16,515,072 sectors. Each sector can be physically addressed based on its corresponding cylinder, head and sector number, e.g. cylinder 437, head 199, sector 12. Various imperfections in the magnetic medium can cause problems with reading data to and from the disk. Areas of thin magnetic material can cause low signal returns and data dropouts. Raised features on the disk can make contact with the read head. The resulting friction can increase the temperature of the read head. This thermal asperity can cause an increase in signal amplitude or data dropins. During manufacture, a test pattern is written to, and read from, each disk sector in physical mode to determine which sectors of the disk are good and are available for storage, and which sectors are bad and should not be used. The effective detection of thermal asperities can improve the performance of magnetic disk drives.

### BRIEF DESCRIPTION OF THE SEVERAL VIEWS OF THE DRAWINGS

FIG. 1 presents a pictorial representation of a disk drive unit 100 in accordance with an embodiment of the present invention.

FIG. 2 presents a block diagram representation of a disk controller 130 in accordance with an embodiment of the present invention.

FIG. 3 presents a block diagram representation of a thermal asperity detector 225 in conjunction with components of disk controller 130 in accordance with an embodiment of the present invention.

FIG. 4 presents a block diagram representation of a thermal asperity detector 225 in accordance with an embodiment of the present invention.

FIG. 5 presents a block diagram representation of a filter module 234 in accordance with an embodiment of the present invention.

FIG. 6 presents a block diagram representation of a programmable filter 250 in accordance with an embodiment of the present invention.

FIG. 7 presents a block diagram representation of a magnitude detector 230 in accordance with an embodiment of the present invention.

FIG. 8 presents a pictorial representation of a handheld audio unit 51 in accordance with an embodiment of the present invention.

FIG. 9 presents a pictorial representation of a computer 52 in accordance with an embodiment of the present invention.

FIG. 10 presents a pictorial representation of a wireless communication device 53 in accordance with an embodiment of the present invention.

FIG. 11 presents a pictorial representation of a personal digital assistant 54 in accordance with an embodiment of the present invention.

FIG. 12 presents a pictorial representation of a laptop computer 55 in accordance with an embodiment of the present invention.

FIG. 13 presents a flowchart representation of a method in accordance with an embodiment of the present invention.

FIG. 14 presents a flowchart representation of a method in accordance with an embodiment of the present invention.

FIG. 15 presents a flowchart representation of a method in accordance with an embodiment of the present invention.

### SUMMARY OF THE INVENTION

The present invention sets forth a disk formatter and methods for use therewith substantially as shown in and/or described in connection with at least one of the figures, as set forth more completely in the claims that follow.

### DETAILED DESCRIPTION OF THE INVENTION INCLUDING THE PRESENTLY PREFERRED EMBODIMENTS

The present invention provides several advantages over the prior art. In an embodiment of the present invention, a thermal asperity detector is presented that detects a thermal asperity and generates thermal asperity data. This thermal asperity data can be used to classify disk sectors as bad during formatting and can be used for generating other diagnostics. In addition, the thermal asperity data can be used by the disk control 130 to vary one or more control parameters, such as amplifier gains, control loop parameters, etc., to more effectively control the operation of the disk drive.

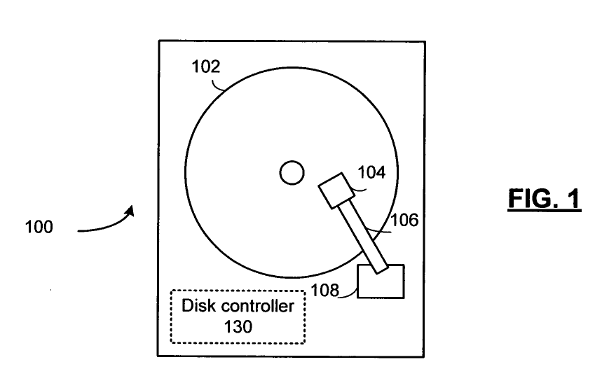

FIG. 1 presents a pictorial representation of a disk drive unit 100 in accordance with an embodiment of the present invention. In particular, disk drive unit 100 includes a disk 102 that is rotated by a servo motor (not specifically shown) at a velocity such as 3600 revolutions per minute (RPM), 4200 RPM, 4800 RPM, 5,400 RPM, 7,200 RPM, 10,000 RPM, 15,000 RPM, however, other velocities including greater or lesser velocities may likewise be used, depending on the particular application and implementation in a host device. In an embodiment of the present invention, disk 102 can be a magnetic disk that stores information as magnetic field changes on some type of magnetic medium. The medium can be a rigid or nonrigid, removable or nonremovable, that consists of or is coated with magnetic material.

Disk drive unit 100 further includes one or more read/write heads 104 that read and write data to the disk via longitudinal magnetic recording (LMR), and/or perpendicular magnetic recording (PMR). The read/write heads 104 are coupled to arm 106 that is moved by actuator 108 over the surface of the disk 102 either by translation, rotation or both. A disk controller 130 is included for controlling the read and write operations to and from the drive, for controlling the speed of the servo motor and the motion of actuator 108, and for providing an interface to and from the host device. Disk controller 130, provides one or more functions or features of the present invention, as described in further detail in conjunction with the figures that follow.

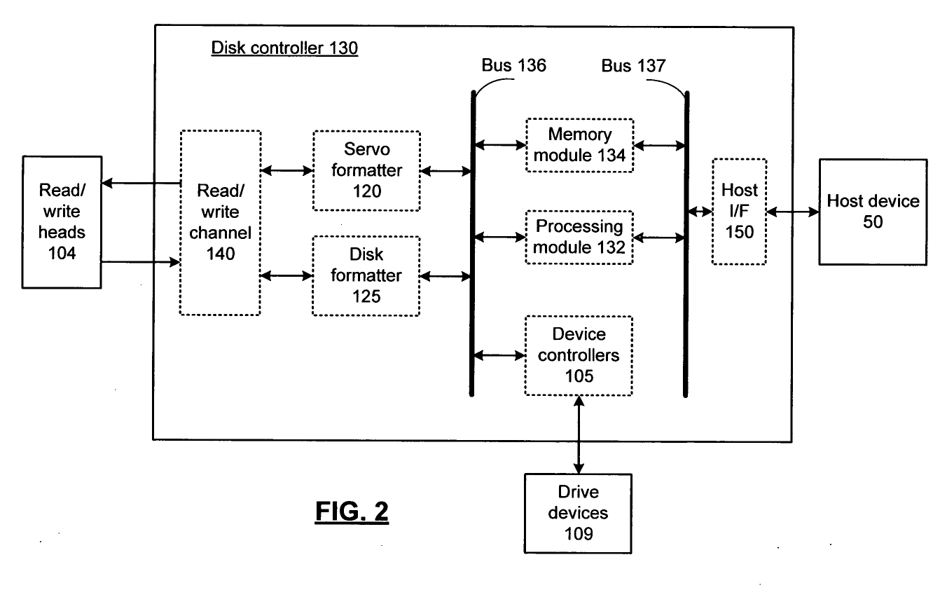

FIG. 2 presents a block diagram representation of a disk controller 130 in accordance with an embodiment of the present invention. In particular, disk controller 130 includes a read/write channel 140 for reading and writing data to and from disk 102 through read/write heads 104. Disk formatter 125 is included for controlling the formatting of data and provides clock signals and other timing signals that control the flow of the data written to, and data read from disk 102 servo formatter 120 provides clock signals and other timing signals based on servo control data read from disk 102, device controllers 105 control the operation of drive devices 109 such as actuator 108 and the servo motor, etc. Host interface 150 receives read and write commands from host device 50 and transmits data read from disk 102 along with other control information in accordance with a host interface protocol. In an embodiment of the present invention the host interface protocol can include, SCSI, SATA, enhanced integrated drive electronics (EIDE), or any number of other host interface protocols, either open or proprietary that can be used for this purpose.

Disk controller 130 further includes a processing module 132 and memory module 134. Processing module 132 can be implemented using a shared processing device or dedicated processing device that includes one or more microprocessors, micro-controllers, digital signal processors, microcomputers, central processing units, field programmable gate arrays, programmable logic devices, state machines, logic circuits, analog circuits, digital circuits, and/or any devices that manipulates signal (analog and/or digital) based on operational instructions that are stored in memory module 134. When processing module 132 is implemented with two or more devices, each device can perform the same steps, processes or functions in order to provide fault tolerance or redundancy. Alternatively, the function, steps and processes performed by processing module 132 can be split between different devices to provide greater computational speed and/or efficiency.

Memory module 134 may be a single memory device or a plurality of memory devices. Such a memory device may be a read-only memory, random access memory, volatile memory, non-volatile memory, static random access memory (SRAM), dynamic random access memory (DRAM), flash memory, cache memory, and/or any device that stores digital information. Note that when the processing module 132 implements one or more of its functions via a state machine, analog circuitry, digital circuitry, and/or logic circuitry, the memory module 134 storing the corresponding operational instructions may be embedded within, or external to, the circuitry comprising the state machine, analog circuitry, digital circuitry, and/or logic circuitry. Further note that, the memory module 134 stores, and the processing module 132 executes, operational instructions that can correspond to one or more of the steps of a process, method and/or function illustrated herein.

Disk controller 130 includes a plurality of modules, in particular, device controllers 105, processing timing generator 110, processing module 132, memory module 134, read/write channel 140, disk formatter 125, servo formatter 120 and host interface 150 that are interconnected via buses 136 and 137. Each of these modules can be implemented in hardware, firmware, software or a combination thereof, in accordance with the broad scope of the present invention. While a particular bus architecture is shown in FIG. 2 with buses 136 and 137, alternative bus architectures that include either a single bus configuration or additional data buses, further connectivity, such as direct connectivity between the various modules, are likewise possible to implement the features and functions included in the various embodiments of the present invention.

In an embodiment of the present invention, one or more modules of disk controller 130 are implemented as part of a system on a chip integrated circuit. In an embodiment of the present invention, this system on a chip integrated circuit includes a digital portion that can include additional modules such as protocol converters, linear block code encoding and decoding modules, etc., and an analog portion that includes additional modules, such as a power supply, disk drive motor amplifier, disk speed monitor, read amplifiers, etc. In a further embodiment of the present invention, the various functions and features of disk controller 130 are implemented in a plurality of integrated circuit devices that communicate and combine to perform the functionality of disk controller 130.

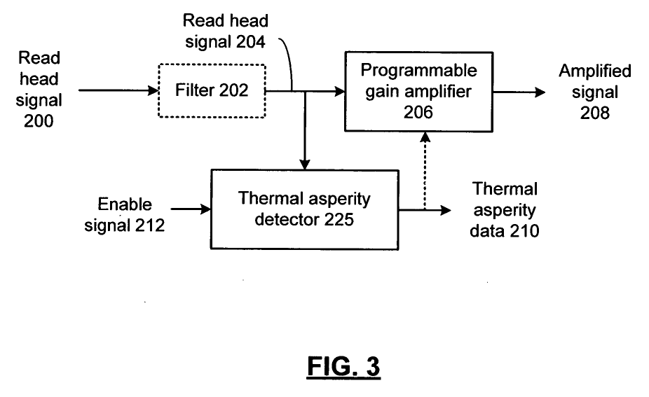

Disk controller 130 includes a thermal asperity detector in accordance with the present invention that will be described in greater detail in conjunction with FIGS. 3 and 4 that follow.

FIG. 3 presents a block diagram representation of a thermal asperity detector 225 in conjunction with components of disk controller 130 in accordance with an embodiment of the present invention. In particular, read head signal 200 from a read head is optionally filtered or otherwise processed by filter 202 to produce read head signal 204. Thermal asperity detector 225 generates thermal asperity data 210. The thermal asperity data 210 can include a thermal asperity flag that is asserted when a thermal asperity is detected or deasserted at the end of a thermal asperity or other data structures that indicate the presence or absence of a thermal asperity. In the embodiment shown, a programmable gain amplifier 206 amplifies the read head signal 204 to produce an amplifier signal 208 that is used by a read/write channel, such as read/write channel 140 to produce read data, such as, control and payload data from the disk, data to control the operation of drive devices 109, and data to format the disk drive, either during initial set-up of the drive or subsequent formatting of the drive.

In an embodiment of the present invention, programmable gain amplifier 206 includes an automatic gain control (AGC) that adapts the gain of the amplifier based on the amplitude of the read head signal 204. Thermal asperity data 210 can be used to adjust the programmable amplifier 206 to hold the gain produced by the AGC to gain levels produced before the thermal asperity for use after the thermal asperity has ended, to adjust/reduce the gain of the programmable amplifier 206 during the period of the thermal asperity to avoid saturation of the programmable gain amplifier and/or to otherwise adapt the gain or AGC parameters of the programmable gain amplifier to compensate for the presence of the thermal asperity that has been detected.

In addition, thermal asperity data 210 can be used by disk controller 130 to adjust other control parameters such as to other freeze other control loops such as servo control loops of the disk drive during the period of the thermal asperity to avoid undesired adaptation based on these transient conditions.

As previously discussed, thermal asperity data can also be used during formatting of the disk drive. During formatting, each sector of the disk 102 is written with a bit pattern, such as a 2T pattern or other test pattern, that can be used to test the read/write ability of the various sectors. The data from each sector of the disk is read and compared with the pattern. The thermal asperity data 210 can be used to identify bad disk sectors during this phase of the disk formatting process that can be eliminated for use by the drive later during the formatting process.

In an embodiment of the present invention, the thermal asperity detector 225 can be selectively enabled or disabled by enable signal 212. In particular, when the enable signal 212 is deasserted, the thermal asperity detector 225 can be disabled and the thermal asperity data 210 can indicate either the disabled condition or can otherwise hold the thermal asperity data at values that indicate the absence of thermal asperities. In this fashion, the disk controller can operate in a test mode and compare test results with the thermal asperity detector 225 enabled and disabled to determine which of these two modes of operation yields better performance and to establish an operating mode based on the results of the test. Further, the thermal asperity detector 225 can be selectively enabled or disabled by the disk controller 130 based on diagnostic signals indicating current operating conditions. In addition, thermal asperity detector 225 can be programmed to be enabled or disabled based on the application or implementation of the disk drive 100.

FIG. 4 presents a block diagram representation of a thermal asperity detector 225 in accordance with an embodiment of the present invention. In particular, thermal asperity detector 225 includes a magnitude detector that produces a magnitude signal 232 from a read head signal 204. In an embodiment of the present invention, the magnitude signal that is based on the magnitude, such as the absolute magnitude of the read head sign 204. Filter module 234 filters the magnitude signal 232 to produce an amplitude signal 236. In an embodiment of the present invention, the filter mode 234 includes a low-pass filter that produces an average amplitude of the magnitude signal in order to filter out higher frequency transients, but with sufficient bandwidth to respond to the increase in amplitude caused by a thermal asperity. This increase in amplitude is detected by a comparator 230 that compares the amplitude signal 236 to a thermal asperity threshold 238 and that generates the thermal asperity data 210 when the amplitude signal 236 compares favorably to the thermal asperity threshold 238. In an embodiment of the present invention, comparator 230 includes a voltage comparator that asserts a thermal asperity flag when the TA threshold is exceeded. In an alternative embodiment, comparator 230 includes an encoder module that generates additional thermal asperity data 210 as discussed in conjunction with FIG. 3.

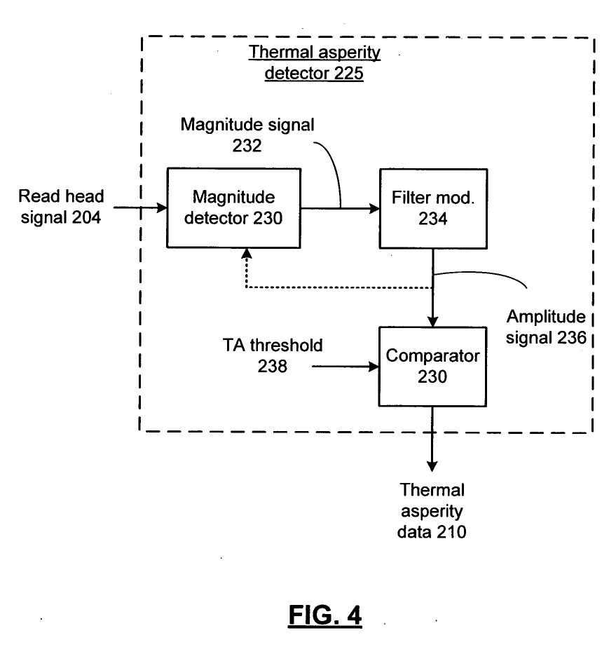

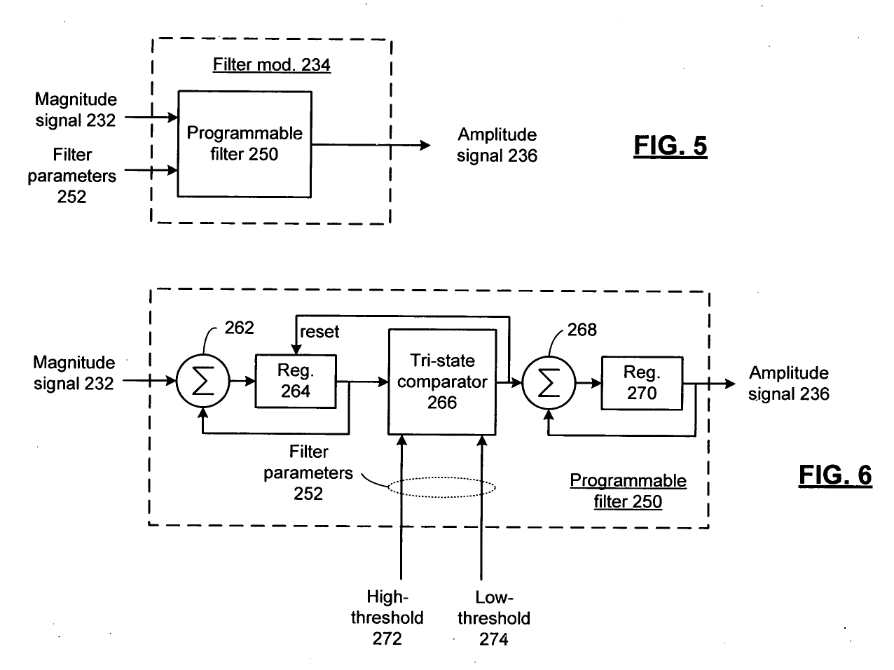

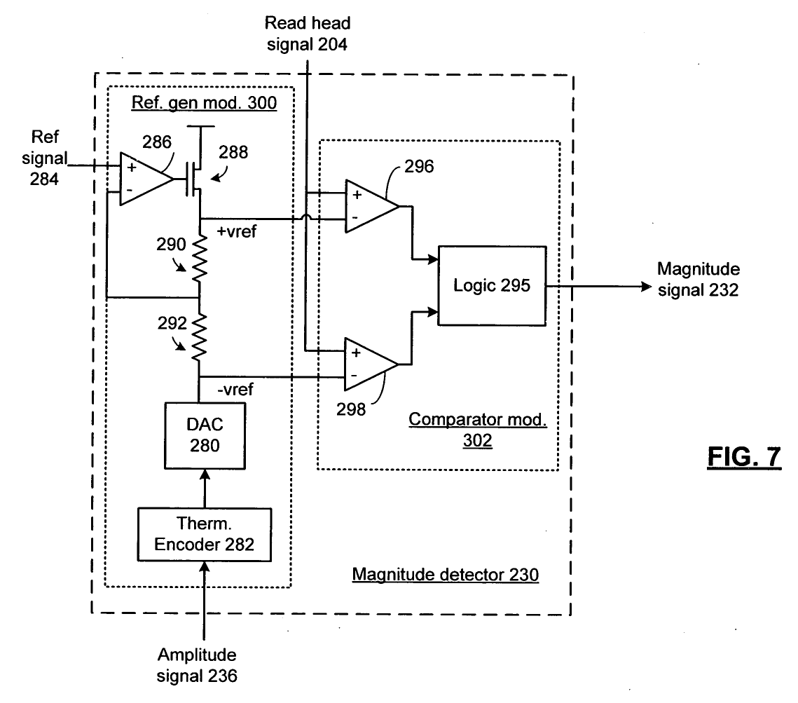

In an embodiment of the present invention, amplitude signal 236 is fed back to magnitude detector 230 in order to adjust one or more thresholds used to generate magnitude signal 232. One possible implementation of magnitude detector 230 is presented in conjunction with FIG. 7 that follows. Embodiments of filter module 234 are presented in conjunction with FIGS. 5 and 6 that follow.

FIG. 5 presents a block diagram representation of a filter module 234 in accordance with an embodiment of the present invention. Filter module 234 includes programmable filter 250 that includes one or more programmable filter parameters 252. These filter parameters can be dynamically chosen by processing module 132 to isolate noise and other undesirable transients present on magnitude signal 232 from the detection of thermal asperities. In a further embodiment of the present invention, the filter parameters 252 are set to implement programmable filter 250 as a matched filter having an impulse response that matches the response of one or more actual thermal asperities that have been observed. Further the filter parameters 252 can be set to control the maximum rise rate of the programmable filter 250 independently from the maximum decay rate. Allowing the rise and decay rates to differ creates a more flexible design and allows the filter to match asymmetrical (upward/downward) characteristics of thermal asperities.

FIG. 6 presents a block diagram representation of a programmable filter 250 in accordance with an embodiment of the present invention. A particular embodiment is shown that implements a potentially asymmetrical filter. In this case, the magnitude signal 232 has a value +1 if the absolute magnitude of the read head signal 204 is above a threshold and −1 if the absolute magnitude of the read head signal 204 is below a threshold. The magnitude signal is accumulated by the summer 262 and register 264 to form an accumulated sum that is input to the tri-state comparator 266. If the accumulated sum reaches or exceeds a programmable high-threshold 272, a second accumulated sum implemented by summer 268 and register 270 is incremented and the register is reset to an initial value.

If the accumulated sum reaches or falls below a programmable low-threshold 274, the second accumulated sum is decremented. In this embodiment, the amplitude signal 236 is assigned the value of the accumulated sum. The high-threshold 272 controls a maximum rate of rise of the amplitude signal 236 and the low-threshold value 274 controls a maximum rate of decay of the amplitude signal 236 to accommodate the expected rise and decay time of the thermal asperity while filtering the effects of higher rate transient signals. As discussed in conjunction with FIG. 5, the high-threshold value and the low-threshold value can be set to different values (at asymmetrical distances from the initial point of register 264) to accommodate asymmetrical thermal asperities or the same value to handle thermal asperities on a symmetrical basis.

During a thermal asperity, higher magnitudes of the read head signal 104 will result in an increase in the value of amplitude signal 236. When the amplitude signal 236 increases above the thermal asperity threshold 238, corresponding thermal asperity data 210 will be created based on the detection of this thermal asperity event.

In an embodiment of the present invention, one or more stages of the filter can be selectively bypassed to allow the amplitude signal 236 to vary more rapidly based on changing conditions in the read head signal 204.

FIG. 7 presents a block diagram representation of a magnitude detector 230 in accordance with an embodiment of the present invention. In this particular embodiment, magnitude detector 230 includes a reference generation module 300 that generates reference voltages +vref and −vref. In operation, reference signal 284 is used to generated a reference current through resistors 290 and 292 by means of transistor 288 and amplifier 286. This reference current is adjusted upward and downward based on feedback from amplitude signals 236 that is encoded by thermometer encoder 282 and digital to analog converter 280 to produce an adjustment current that operates to adjust the reference voltages based on the average amplitude of the read head signal reflected by the amplitude signal 236. The reference voltages are chosen to reflect a substantial increase in positive and negative amplitude above the average amplitude 236.

Comparator module 302 includes comparators 296 and 298 and logic 295 to generate magnitude signal 232 by comparing the read head signal 204 to the reference voltages +vref and −vref and generating a first value of the magnitude signal when the read head signal 204 compares favorably to +vref and when the read head signal compares favorably to the −vref, and that generates a second value of the magnitude signal when the read head signal compares unfavorably to the reference voltage +vref and unfavorably to the reference voltage −vref. In an embodiment of the present invention, the logic 295 generates a magnitude signal 232 that represents +1 when the magnitude of read head signal 204 is above +vref or below −vref and that represents −1 otherwise.

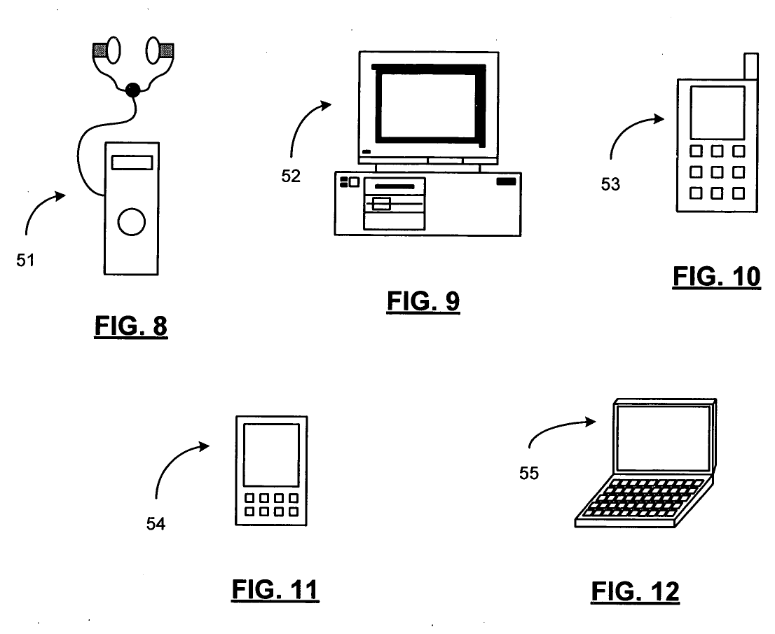

FIG. 8 presents a pictorial representation of a handheld audio unit 51 in accordance with an embodiment of the present invention. In particular, disk drive unit 100 can include a small form factor magnetic hard disk whose disk 102 has a diameter 1.8″ or smaller that is incorporated into or otherwise used by handheld audio unit 51 to provide general storage or storage of audio content such as motion picture expert group (MPEG) audio layer 3 (MP3) files or Windows Media Architecture (WMA) files, video content such as MPEG4 files for playback to a user, and/or any other type of information that may be stored in a digital format.

FIG. 9 presents a pictorial representation of a computer 52 in accordance with an embodiment of the present invention. In particular, disk drive unit 100 can include a small form factor magnetic hard disk whose disk 102 has a diameter 1.8″ or smaller, a 2.5″ or 3.5″ drive or larger drive for applications such as enterprise storage applications. Disk drive 100 is incorporated into or otherwise used by computer 52 to provide general purpose storage for any type of information in digital format. Computer 52 can be a desktop computer, or an enterprise storage devices such a server, of a host computer that is attached to a storage array such as a redundant array of independent disks (RAID) array, storage router, edge router, storage switch and/or storage director.

FIG. 10 presents a pictorial representation of a wireless communication device 53 in accordance with an embodiment of the present invention. In particular, disk drive unit 100 can include a small form factor magnetic hard disk whose disk 102 has a diameter 1.8″ or smaller that is incorporated into or otherwise used by wireless communication device 53 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats that may be captured by an integrated camera or downloaded to the wireless communication device 53, emails, webpage information and other information downloaded from the Internet, address book information, and/or any other type of information that may be stored in a digital format.

In an embodiment of the present invention, wireless communication device 53 is capable of communicating via a wireless telephone network such as a cellular, personal communications service (PCS), general packet radio service (GPRS), global system for mobile communications (GSM), and integrated digital enhanced network (iDEN) or other wireless communications network capable of sending and receiving telephone calls. Further, wireless communication device 53 is capable of communicating via the Internet to access email, download content, access websites, and provide steaming audio and/or video programming. In this fashion, wireless communication device 53 can place and receive telephone calls, text messages such as emails, short message service (SMS) messages, pages and other data messages that can include attachments such as documents, audio files, video files, images and other graphics.

FIG. 11 presents a pictorial representation of a personal digital assistant 54 in accordance with an embodiment of the present invention. In particular, disk drive unit 100 can include a small form factor magnetic hard disk whose disk 102 has a diameter 1.8″ or smaller that is incorporated into or otherwise used by personal digital assistant 54 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats, emails, webpage information and other information downloaded from the Internet, address book information, and/or any other type of information that may be stored in a digital format.

FIG. 12 presents a pictorial representation of a laptop computer 55 in accordance with an embodiment of the present invention. In particular, disk drive unit 100 can include a small form factor magnetic hard disk whose disk 102 has a diameter 1.8″ or smaller, or a 2.5″ drive. Disk drive 100 is incorporated into or otherwise used by laptop computer 52 to provide general purpose storage for any type of information in digital format.

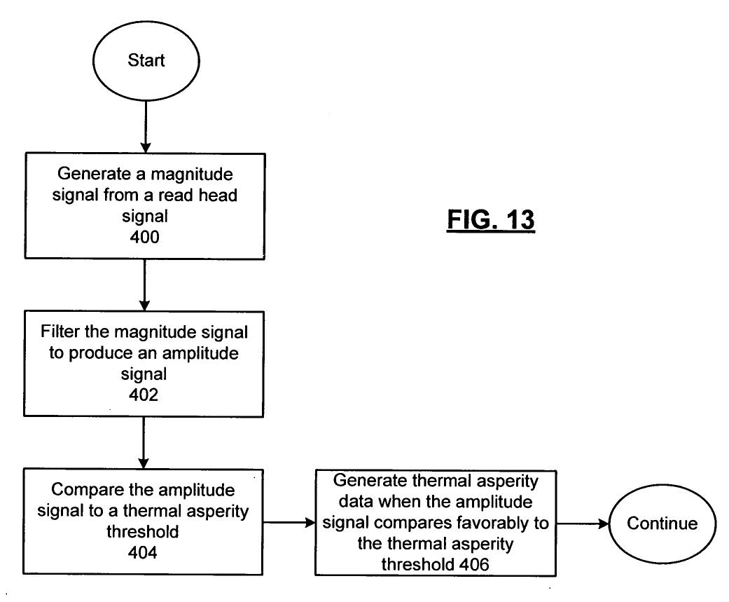

FIG. 13 presents a flowchart representation of a method in accordance with an embodiment of the present invention. In particular, a method is presented that can be used in conjunction with one or more of the features or functions described in association with FIGS. 1-12. In step 400, a magnitude signal is generated from a read head signal. In step 402, the magnitude signal is filtered to produce an amplitude signal. In step 404, the amplitude signal is compared to a thermal asperity threshold. In step 406, thermal asperity data is generated when the amplitude signal compares favorably to the thermal asperity threshold.

In an embodiment of the present invention step 402 is programmable based on at least one filter parameter. These filter parameter can include a first parameter that controls a maximum rate of rise of the amplitude signal and/or a second parameter that controls a maximum rate of decay of the amplitude signal that can be either the same or different from the maximum rate of rise.

In an embodiment, step 400 can include generating a first reference voltage and a second reference voltage, generating a first value of the magnitude signal when the read head signal compares favorably to the first reference voltage and when the read head signal compares favorably to the second reference voltage, and generating a second value of the magnitude signal when the read head signal compares unfavorably to the first reference voltage and unfavorably to the second reference voltage. The first reference voltage and the second reference voltage can be adjusted based on the amplitude signal.

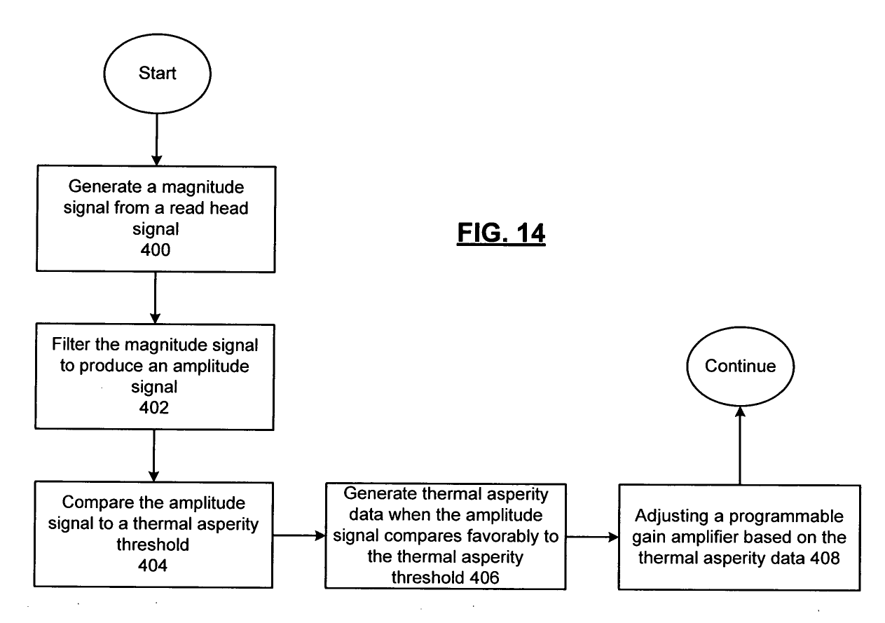

FIG. 14 presents a flowchart representation of a method in accordance with an embodiment of the present invention. In particular, a method is presented that includes many of the steps described in conjunction with FIG. 13 that are referred to by common reference numerals. In addition, step 408 is included for adjusting a programmable gain amplifier based on the thermal asperity data. In an embodiment of the present invention, step 408 includes adjusting the gain of the programmable gain amplifier based on the thermal asperity data.

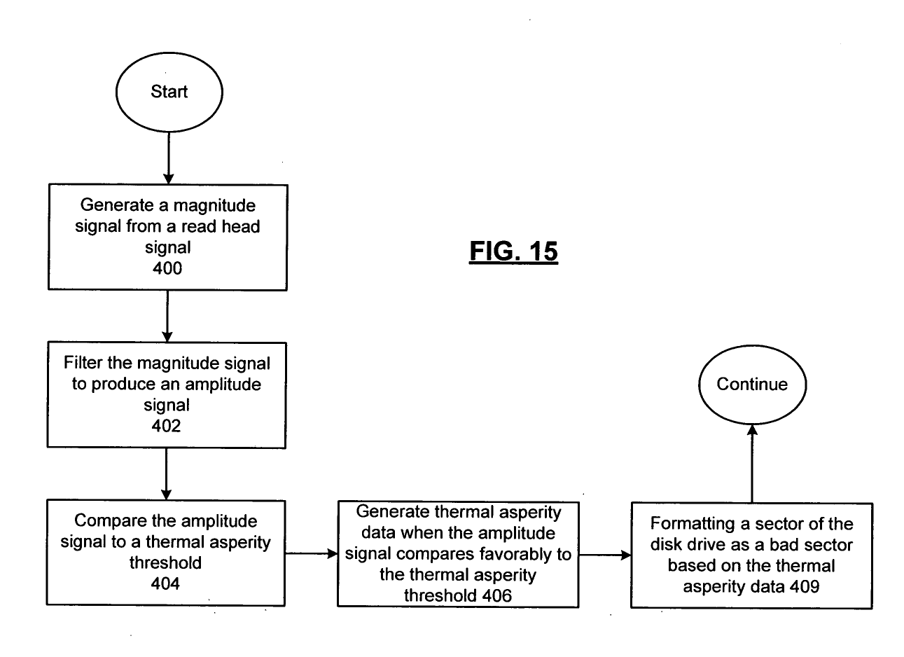

FIG. 15 presents a flowchart representation of a method in accordance with an embodiment of the present invention In particular, a method is presented that includes many of the steps described in conjunction with FIG. 13 that are referred to by common reference numerals. In addition, step 409 is included for formatting a sector of the disk drive as a bad sector based on the thermal asperity data.

While the present invention has been described in terms of a magnetic disk, other nonmagnetic storage devices including optical disk drives including compact disks (CD) drives such as CD-R and CD-RW, digital video disk (DVD) drives such as DVD-R, DVD+R, DVD-RW, DVD+RW, etc can likewise be implemented in accordance with the functions and features of the presented invention described herein.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The various circuit components can be implemented using 0.35 micron or smaller CMOS technology. Provided however that other circuit technologies, both integrated or non-integrated, may be used within the broad scope of the present invention. Likewise, various embodiments described herein can also be implemented as software programs running on a computer processor. It should also be noted that the software implementations of the present invention can be stored on a tangible storage medium such as a magnetic or optical disk, read-only memory or random access memory and also be produced as an article of manufacture.

Thus, there has been described herein an apparatus and method, as well as several embodiments including a preferred embodiment, for implementing a memory and a processing system. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A thermal asperity detector for use in a hard disk drive, the thermal asperity detector comprising:
a magnitude detector that produces a magnitude signal from a read head signal;
a filter module, coupled to the magnitude detector, that filters the magnitude signal to produce an amplitude signal; and
a comparator, coupled to the filter module, that compares the amplitude signal to a thermal asperity threshold and that generates thermal asperity data when the amplitude signal compares favorably to the thermal asperity threshold.

2. The thermal asperity detector of claim 1 wherein the filter module includes a programmable filter that is programmable based on at least one filter parameter.

3. The thermal asperity detector of claim 2 wherein the at least one filter parameter includes a first parameter that controls a maximum rate of rise of the amplitude signal.

4. The thermal asperity detector of claim 3 wherein the at least one filter parameter includes a second parameter that controls a maximum rate of decay of the amplitude signal that is different from the maximum rate of rise.

5. The thermal asperity detector of claim 1 wherein the magnitude detector includes:
a reference generation module that generates a first reference voltage and a second reference voltage; and
a comparator module, coupled to the reference generation module that generates a first value of the magnitude signal when the read head signal compares favorably to the first reference voltage and when the read head signal compares favorably to the second reference voltage, and that generates a second value of the magnitude signal when the read head signal compares unfavorably to the first reference voltage and unfavorably to the second reference voltage.

6. The thermal asperity detector of claim 5 wherein the magnitude detector adjusts the first reference voltage and the second reference voltage based on the amplitude signal.

7. A method for use in a disk drive, the method comprising:
generating a magnitude signal from a read head signal;
filtering the magnitude signal to produce an amplitude signal;
comparing the amplitude signal to a thermal asperity threshold; and
generating thermal asperity data when the amplitude signal compares favorably to the thermal asperity threshold.

8. The method of claim 7 wherein the step of filtering is programmable based on at least one filter parameter.

9. The method of claim 8 wherein the at least one filter parameter includes a first parameter that controls a maximum rate of rise of the amplitude signal.

10. The method of claim 9 wherein the at least one filter parameter includes a second parameter that controls a maximum rate of decay of the amplitude signal that is different from the maximum rate of rise.

11. The method of claim 7 wherein the step of generating the magnitude signal includes:
generating a first reference voltage and a second reference voltage;
generating a first value of the magnitude signal when the read head signal compares favorably to the first reference voltage and when the read head signal compares favorably to the second reference voltage; and
generating a second value of the magnitude signal when the read head signal compares unfavorably to the first reference voltage and unfavorably to the second reference voltage.

12. The method of claim 11 wherein the step of generating the magnitude signal includes:
adjusting the first reference voltage and the second reference voltage based on the amplitude signal.

13. The method of claim 7 further comprising:
adjusting a programmable gain amplifier based on the thermal asperity data.

14. The method of claim 13 wherein the step of adjusting the programmable gain amplifier includes adjusting the gain of the programmable gain amplifier based on the thermal asperity data.

15. The method of claim 7 further comprising:
formatting a sector of the disk drive as a bad sector based on the thermal asperity data.
